(19) United States
(12) Patent Application Publication
(10) Pub. No.: US 2022/0392686 A1
(43) Pub. Date: Dec. 8, 2022

(54) COMBINED METAL POWDER MAGNETIC CORE AND INDUCTANCE DEVICE FORMED BY SAME

(71) Applicants: EAGLERISE INTELLIGENT DEVICE CORPORATION LTD., Foshan, Guangdong (CN); FOSHAN EAGLERISE POWER SCIENCE & TECHNOLOGY (SHUNDE) CO., LTD., Foshan, Guangdong (CN)

(72) Inventors: Juncheng Xiao, Foshan, Guangdong (CN); Yilong Wang, Foshan, Guangdong (CN); Kakuryo Sho, Foshan, Guangdong (CN)

(21) Appl. No.: 17/773,662

(22) PCT Filed: Mar. 9, 2021
(86) PCT No.: PCT/CN2021/079712

§ 371 Date: May 2, 2022

(30) Foreign Application Priority Data
Aug. 5, 2020 (CN) 202010775421.7

(51) Int. Cl. H01F 27/255; H01F 27/28

(52) U.S. Cl. CPC H01F 27/255; H01F 27/28

(57) ABSTRACT

A combined metal powder magnetic core and an inductance device formed by same. The combined metal powder magnetic core comprises upper and lower magnet yokes and core columns arranged therebetween; wherein the upper and lower magnet yokes are respectively C-shaped, two ends of the upper and lower magnet yokes are respectively butted with the two core columns to form a magnetic loop, an air gap is arranged at the butted position between the upper and lower magnet yokes, and the interval of the central areas of the air gap is smaller than that of the marginal areas thereof.

### TECHNICAL FIELD

The present disclosure relates to combined metal powder magnetic cores and inductance devices formed therefrom.

### BACKGROUD OF THE INVENTION

A Chinese invention patent (CN201880024695.3, titled “Reactor”, published as CN110832609A) has proposed solutions to two problems (referring to its FIGS. 1 and 2). One is solved by configuring core pieces 3A, 3B to be formed by molded bodies of a composite material that includes a magnetic powder and a resin. The molded bodies of the composite material can reduce the relative permeability due to the fact that the resin is interposed between powder particles of the magnetic powder. For this reason, if the core pieces 3A, 3B forming a magnetic core 3 are molded bodies of a composite material, there is no need to provide gaps for adjusting the inductance of a reactor 1 in the magnetic core 3 (e.g., between the core pieces 3A, 3B), or if gaps are provided, the gaps may be small. Accordingly, magnetic flux leakage is not likely to occur in the magnetic core 3 (inner core portions 31), and clearances 34 between the inner peripheral surfaces of a wound portions 2c and the outer peripheral surfaces of the inner core portions 31 can be made small. That is, by improving the material properties of molded bodies of a composite material, there will be small or no gap between the magnetic cores, thereby suppress the generation of magnetic flux leakage. The other is solved by chamfering the corner portions 313 of the inner core portions 31. Due to the corner portions 313 of the inner core portions 31 being chamfered, the clearances 34 at the corner portions 313 are larger, the flow paths of the resin (flow path cross-sectional area) are easily ensured, and the formation of inner resin portions 41 is easier. The magnetic flux is not likely to flow in the corner portions 313 of the inner core portions 31, and the corner portions 313 are not likely to function as effective magnetic paths, and therefore have a comparatively small influence on the effective magnetic path. For this reason, due to the corner portions 313 of the inner core portions being chamfered, it is possible to effectively suppress reduction of the effective magnetic path cross-sectional area while ensuring the flow paths of the resin. That is to say, the flow of the magnetic flux on the magnetic paths of the magnetic core can be improved by chamfering the chamfering the corner portions 313; i.e. by arranging chamfer along the direction of the magnetic path extending from the top to the bottom of the magnetic core body, magnetic flux leakage is not likely to occur.

For applications such as boost inductors for vehicles, inductors for photovoltaic inverters, PFC inductors for charging piles and the like that operate at heavy current, large power, and high power density, such inductors are required to have a very high inductance-current product coefficient L*I objectively so as to prevent issues caused by a sharp drop in inductance under heavy current. In order to realize the design of such power inductors, the magnetic core materials of these inductors may generally be realized by the aforesaid solutions and metal pressed powder magnetic core with relatively low magnetic conductivity (μr: 20-200), but to improve their abilities in the application of large currents, a non-magnetically conductive space with a certain degree of thickness in millimeters shall be introduced as an air gap of the magnetic core intentionally at the splicing of the magnetic core. However, substances in the so-called non-magnetically conductive space, such as air, do not completely block the magnetic field in the air gap of the magnetic core. Such substances, due to their relative permeability μr of 1 being close to that of the vacuum, may have a lower permeability than that of the composite magnetic core; in this connection, the so-called non-magnetic substances and even the vacuum space may still be important in magnetic flux shunting, although the magnetic resistance is relatively large. This phenomenon is often explained as magnetic leakage. Under the excitation of high frequency and large current, for the alternating magnetic flux circulating in the non-magnetic substances at the air gaps of the magnetic core or the space, a large part of leakage magnetic flux may directly penetrate the copper wire surface of the surrounding winding coil, leading to serious eddy current loss on the coil due to high current applying on the coil and thick winding copper wire.

### SUMMARY OF THE INVENTION

In order to significantly improve the influence of the large air gap caused by the application of high current and large power density, which further leads to a large amount of leakage magnetic flux around the air gap penetrating the surface of the copper wire to form the eddy current, the present disclosure first sets forth a solution by configuring the shape of the magnetic core at the splicing of the magnetic path of the magnetic core. A combined metal powder magnetic core provided herein may comprise upper and lower magnet yokes and core columns arranged therebetween, wherein each of the upper and lower magnet yokes is C-shaped, two ends of upper and lower magnet yokes are respectively butted with the two core columns to form a magnetic loop, and air gaps are arranged at the butted positions between the magnet yokes and the core columns. The interval at the central area of respective air gap is smaller than the interval at the marginal area thereof.

In this connection, the magnet yokes being C-shaped actually defines that chamfers of both shoulders on both sides of each magnet yoke make each magnet yoke look like C-shaped as a whole. Shoulders of each magnet yoke being chamfered can greatly reduce the magnetic flux leakage at there, thereby not only reducing the magnetic loss, and more importantly, avoiding serious eddy current damage to other surrounding parts containing magnet (such as pieces of iron, copper wires) caused by magnetic flux leakage when running at high power.

In this connection, the interval at the central area of the air gap is much smaller than the interval at the marginal area thereof; that is, it actually increases the interval at the marginal area of the air gap to allow that the magnetic resistance at the central area of the air gap is much smaller than that at the marginal area, so that the magnetic field moves closer to the central area to reduce the magnetic flux leakage, thereby reducing the eddy current caused by the magnetic flux leakage to the surrounding copper wires. In this connection, there is a smooth transition between the central area and the marginal area. In order to achieve this structure, there are various ways to achieve it. For example, at least one of the corner portions at the upper and lower yokes or the core columns is configured as a chamfer. The corner portion at the air gap being a chamfer defines that the surface of the magnetic core forming the air gap is configured in a chamfered structure. Such chamfered structure may be either a rounded one or a chamfered one. Furthermore, the chamfered structure is obviously not a manufacturing chamfer that usually exists in traditional chamfering process, nor a commonly referred to as deburring rounding; instead, it may be a chamfer having a rounding angle much larger than the angle of the manufacturing chamfer and that of the deburring rounding. The radius of the manufacturing chamfer or that of the deburring rounding may not be greater than 0.5 mm in product manufacture.

Compared with the prior art, according to the structure disclosed herein, the magnet yokes are C-shaped, so that the magnetic flux leakage at shoulder parts of the magnet yokes can be greatly reduced, thereby reducing magnetic loss; then, as the interval between the marginal area of the air gap is increased, magnetic resistance of the central areas of the air gap is far smaller than that of the marginal area, so that a magnetic field is close to the central areas to reduce magnetic flux leakage, and eddy current caused by magnetic flux leakage to peripheral copper wires is reduced.

In a further embodiment, the chamfer is a rounded corner having a radius greater than the interval at the central area of the air gap.

In a further embodiment, the chamfer is an oblique angle of 45°, and the side length of the oblique angle is greater than the interval at the central area of the air gap.

In a further embodiment, the upper and lower magnet yokes are an integrally formed magnetic core, and the core columns are formed by splicing a plurality of magnetic blocks. This can further improve the applicability to high magnetic field intensity.

In a further embodiment, in a direction perpendicular to a surface of the magnetic core at the central area of the air gap, a tapered magnetic core that gradually decreases in cross section towards the air gap is formed.

An inductance device applying the combined metal powder magnetic core according to any one of claims 1 to 4 is also provided herein. The inductance device may comprise two coil windings and the combined metal powder magnetic core according to any one of claims 1 to 4, wherein one of the core columns is inserted into one of the coil windings, and both ends of each of the upper and lower magnet yokes are partially inserted into a central space defined by the coil windings so that the air gaps are surrounded by the coil windings.

In a further embodiment, each core column is combined by two sub-columns arranged in an up-down direction.

In a further embodiment, the inductance device may further comprise an outer holder in which the combined metal powder magnetic core and the coil windings are pressed.

Since the present disclosure has the above-mentioned features and advantages, it can be applied to the combined metal powder magnetic core and the inductance device. The inductance device may include a high-current transformer, an adapter, a reactance, a PFC inductance for a charging pile, and the like.

### BRIEF DESCRIPTION OF THE DRAWINGS

FIG. 1 is a schematic diagram of an inductance device according to the present disclosure.

### DETAILED DESCRIPTION

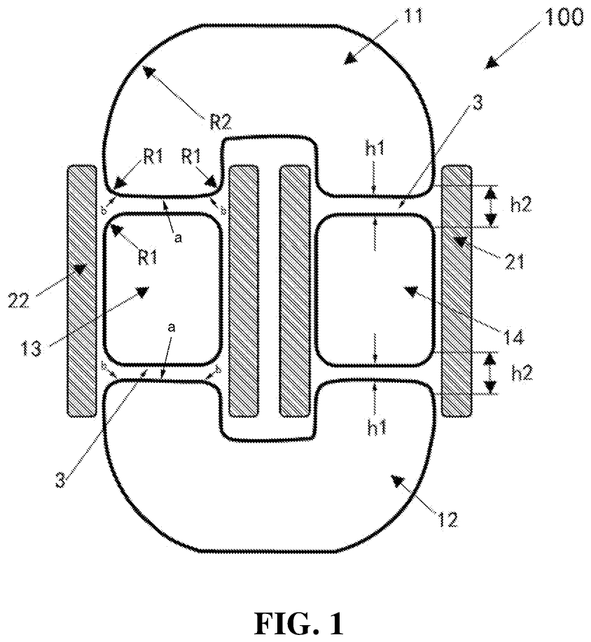

Hereinafter, the structures of the combined metal powder magnetic core and the inductance device according to the present disclosure will be further described in detail with reference to the accompanying drawings. As shown in FIG. 1, an inductance device 100 includes a combined metal powder magnetic core and coil windings 21, 22. The present disclosure first sets forth a solution by modifying the shape of the magnetic core at the splicing of the magnetic path of the magnetic core; i.e., configuring a combined metal powder magnetic core to comprise upper and lower magnet yokes 11, 12 and core columns 13, 14 arranged between the upper and lower magnet yokes 11, 12. The upper and lower magnet yokes 11, 12 may be respectively C-shaped. The magnet yokes being C-shaped actually defines that both shoulders on both sides of each magnet yoke each have a chamfer R2, and the chamfer R2 may be preferably in a large rounded structure such that each magnet yoke is C-shaped as a whole. Both shoulders of each magnet yoke being chamfered can greatly reduce the magnetic flux leakage at there, thereby not only reducing the magnetic loss, and more importantly, avoiding serious eddy current damage to other surrounding parts containing magnet (such as pieces of iron, copper wires) caused by magnetic flux leakage when running at high power.

In this connection, two ends of the upper and lower magnet yokes 11, 12 are respectively butted with the two core columns 13, 14 to form a magnetic loop, and air gaps are arranged at the butted positions between the magnet yokes and the core columns. In terms of the air gap 3 at one butted position between the one end of one magnet yoke and one core column, the interval h1 at the central area a of the air gap 3 is much smaller than the interval h2 at the marginal area b thereof, and there is a smooth transition between the central area a and the marginal area b. In this regard, the corner portions of the upper and lower magnet yokes 11, 12 and those of the core columns 13, 14 at the air gaps 3 can all be configured as chamfers. The maximum interval defined by each of the chamfer in the up-down direction constitutes the interval h2 at the marginal area b. Of course, in another embodiment, a chamfer may also be arranged in the orientation of one side to increase the interval h2 at the marginal area b of the air gap 3.

In this connection, the chamfer may be a rounded corner R1 having a radius greater than the interval h1 at the central area of the air gap 3, preferably greater than 1.5 times h1. In another embodiment (not shown in the FIGURE), the chamfer may be an oblique angle of 45°, and the side length of the oblique angle may be greater than the interval at the central area of the air gap 3, preferably greater than 1.5 times h1. Such structures actually increases the interval at the marginal area of the air gap to allow that the magnetic resistance at the central area of the air gap is much smaller than that at the marginal area, so that the magnetic field moves closer to the central area to reduce the magnetic flux leakage, thereby reducing the eddy current caused by the magnetic flux leakage to the surrounding copper wires. Compared with the traditional solution using a square iron core, under the same working conditions, the magnetic flux leakage penetrated within the cross-sectional area of the coil windings according to the present disclosure is greatly reduced, as such the high-frequency eddy current losses of the coil windings are also greatly reduced.

The interval at h1 the central area of each air gap 3 may refer to the interval h1 of the central area of each air gap 3 having a millimeter-level (or above but not limit) thickness and h1 may be a magnetic core splicing that is almost close to 0; in this respect, it may also have the effect of reducing the magnetic flux leakage penetrating the coil surface at the splicing.

In this connection, the chamfered structure is obviously not a manufacturing chamfer that usually exists in traditional chamfering process, nor a commonly referred to as deburring rounding; instead, it may be a chamfer having a rounding angle much larger than the angle of the manufacturing chamfer and that of the deburring rounding. The radius of the manufacturing chamfer or that of the deburring rounding may not be greater than 0.5 mm in product manufacture.

In a further embodiment, the upper and lower magnet yokes 11, 12 may be an integrally formed magnetic core, and the core columns 13, 14 may be formed by splicing a plurality of magnetic blocks. This can further improve the applicability to high magnetic field intensity.

The embodiment according to the present disclosure shown in the FIGURE illustrates a rounded magnetic core in a plane direction. In another embodiment, in a direction perpendicular to a surface of the magnetic core at the central area of the air gap, a tapered magnetic core that gradually decreases in cross section towards the air gap 3 is formed. Such tapered magnetic core also has the effect of the present disclosure, and is also one main embodiment of the present disclosure.

The present disclosure further provides an inductance device 100 applying the combined metal powder magnetic core according to any one of claims 1 to 4. The inductance device may comprise two coil windings 21, 22 and the combined metal powder magnetic core, one of the core columns 13, 14 may be inserted into one of the coil windings 21, 22, and both ends of each of the upper and lower magnet yokes 11, 12 may partially be inserted into a central space defined by the coil windings 21, 22 so that the air gaps 3 may also be surrounded by the coil windings 21, 22. In this connection, the core columns 13, 14 may be in the form of one piece, or they may be combined by two or more sub-columns (not shown in the FIGURE) so as to be adapted to coil windings 21, 22 that have different intervals at the central areas.

The coil windings according to the present disclosure can be formed by one coil on the left and one coil on the right as shown in FIG. 1. Alternatively, they may be formed by multiple several coils arranged in a unilateral magnetic path as long as the air gaps formed by splicing the magnetic cores are positioned within the central space defined by the coils and have the above-mentioned features, in this connection, such coil windings still have the practical effect of the present disclosure.

In a further embodiment, an outer holder (not shown in the FIGURE) may also be included, in which the combined metal powder magnetic core and the coil windings 21, 22 are pressed. The outer holder is configured to position the combined metal powder magnetic core and to position the coil windings 21, 22 to prevent them from loosening.

1. A combined metal powder magnetic core, comprising upper and lower magnet yokes and core columns arranged between the upper and lower magnet yokes, the upper and lower magnet yokes each being C-shaped, two ends of upper and lower magnet yokes being respectively butted with the two core columns to form a magnetic loop, and air gaps being arranged at butted positions between the magnet yokes and the core columns, an interval at central area of respective air gap being smaller than an interval at marginal area thereof.

2. The combined metal powder magnetic core according to claim 1, wherein at least one of corner portions at the upper and lower magnet yokes or the core columns is configured as a chamfer.

3. The combined metal powder magnetic core according to claim 2, wherein the chamfer is a rounded corner having a radius greater than the interval at the central area of the air gap.

4. The combined metal powder magnetic core according to claim 2, wherein the chamfer is an oblique angle of 45°, and side length of the oblique angle is greater than the interval at the central area of the air gap.

5. The combined metal powder magnetic core according to claim 1, wherein the upper and lower magnet yokes are an integrally formed magnetic core, and the core columns are formed by splicing a plurality of magnetic blocks.

6. The combined metal powder magnetic core according to claim 1, wherein in a direction perpendicular to a surface of the magnetic core at the central area of the air gap, a tapered magnetic core that gradually decreases in cross section towards the air gap is formed.

7. An inductance device applying the combined metal powder magnetic core according to claim 1, comprising two coil windings and the combined metal powder magnetic core according to claim 1, one of the core columns being inserted into one of the coil windings, and both ends of each of the upper and lower magnet yokes being partially inserted into a central space defined by the coil windings so that the air gaps are surrounded by the coil windings.

8. The inductance device according to claim 7, wherein each core column is combined by two sub-columns arranged in an up-down direction.

9. The inductance device according to claim 7, further comprising an outer holder in which the combined metal powder magnetic core and the coil windings are pressed.
